(19) United States
(12) Patent Application Publication
(10) Pub. No.: US 2008/0271322 A1
(43) Pub. Date: Nov. 6, 2008

(54) Art knife

(76) Inventor: Michael Chen, Hsin Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/797,515

(22) Filed: May 4, 2007

(51) Int. Cl. B26B 3/06

(52) U.S. Cl. 30/162

(57) ABSTRACT

An art knife comprised of a case, the case consisting of a left case half and a right case half, with a blade control mechanism capable of reciprocal movement contained in the interior section of the art knife. The blade control mechanism includes a semicircular, saddle-shaped push button that enables left- and right-handed operation during the cutting of an object which, based on the angle and orientation of the object, obtains the most appropriate directional application of force. Additionally, a blade replacement key is disposed that provides for convenient blade changing, the overall arrangement of the invention herein thereby enhancing art knife utility and, furthermore, increasing manufacturing practical value.

### BACKGROUND OF THE INVENTION

1) Field of the Invention

The invention relates to an art knife comprised of a case, said case consisting of a left case half and a right case half, with a blade control mechanism capable of reciprocal movement contained in the interior section of the art knife. Said blade control mechanism includes a semicircular, saddle-shaped push button that enables left- and right-handed operation during the cutting of an object which, based on the angle and orientation of the object, obtains the most appropriate directional application of force. Additionally, a blade replacement key is disposed that provides for convenient blade changing, the overall arrangement of the present invention thereby enhancing art knife utility and, furthermore, increasing manufacturing practical value.

2) Description of the Prior Art

Art knives are instruments that provide for the cutting of objects and, since they must meet the requirements of various work situations, a range of different art knives have appeared on the market, the typical art knife having in its case, a trapezoidal blade, the cutting edge of said blade formed along the long bottom side of its trapezoidal profile, such that when the user pushes the blade past the exterior, the sharp corner of the blade extends outside the case to provide for user cutting; and in conventional art knives, said push button protrudes from a slot in the upper extent and lateral edge of the case, such that user only has to shove the push button to extend the blade from front end of the art knife case.

However, due to left- and right-handed usage differences and, furthermore, in the cutting of each object, the directional dissimilarities, therefore, the left- or right-handed grasping of the conventional art knife, when cutting objects at differing directions and angles, often results in the feeling that cutting is extremely awkward, a situation that leads to less than optimal cutting and, furthermore, a deficiency that may even bring about serious user injury.

In view of the existent shortcomings of the conventional product that await improvement, the inventor of the invention herein, based on professional knowledge and design experience gained while engaged in the relevant fields, conducted research that culminated in the design of the improved structure art knife of the invention herein.

### SUMMARY OF THE INVENTION

The objective of the invention herein is to provide an art knife structure comprised of a case, said case consisting of a left case half and a right case half, with a blade control mechanism capable of reciprocal movement contained in the interior section of the art knife; said blade control mechanism includes a semicircular, saddle-shaped push button that enables left- and right-handed operation during the cutting of an object which, based on the angle and orientation of the object, obtains the most appropriate directional application of force; additionally, a blade replacement key is disposed that provides for convenient blade changing, the overall arrangement of the present invention thereby enhancing art knife utility and, furthermore, increasing manufacturing practical value.

To achieve said objectives, the detailed description of the most preferred embodiments of the invention herein are accompanied by the brief description of the drawings below to thereby provide the examination committee a further understanding of the advantages, objectives, and functions of the present invention.

### BRIEF DESCRIPTION OF THE DRAWINGS

FIG. 1 is an isometric drawing of the invention herein.

FIG. 2 is an exploded drawing of the invention herein.

FIG. 3 is an exploded drawing of the blade control mechanism 4.

FIG. 4 is an isometric drawing of the push button bearing mount 7, as viewed from the rear.

### DETAILED DESCRIPTION OF THE PREFERRED EMBODIMENTS

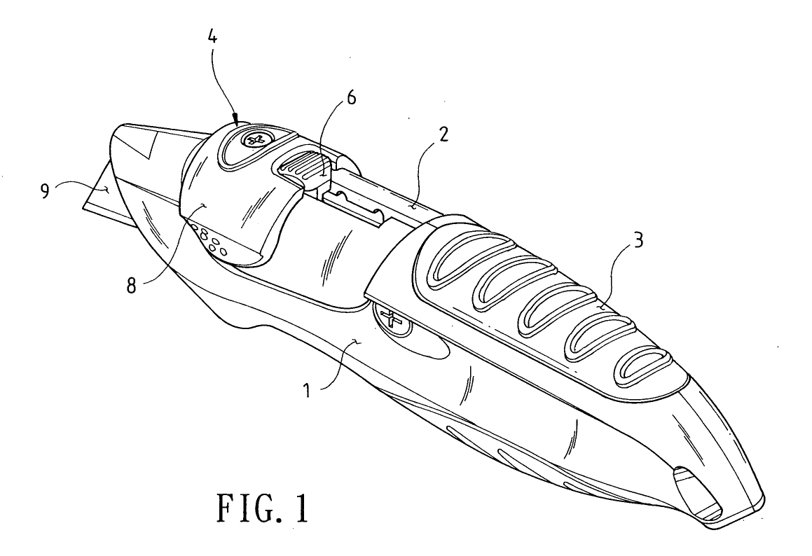

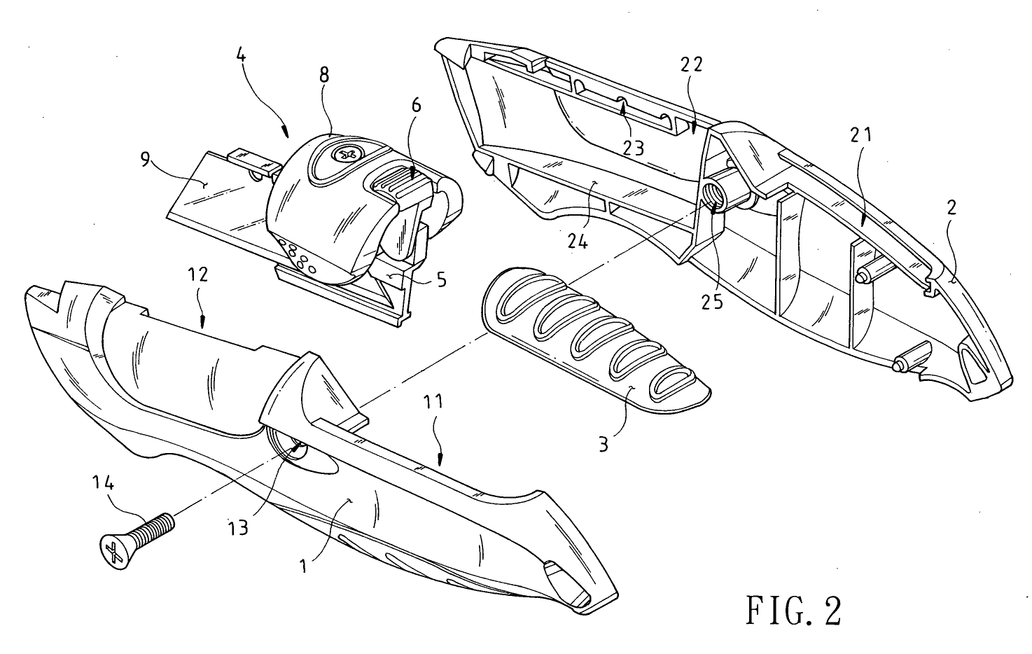

Referring to FIG. 1 and FIG. 2, the art knife of the invention herein is comprised of a left case half 1, a right case half 2, a pad 3, and a blade control mechanism 4, wherein:

The left case half 1 is a shell of one-piece molded construction having a reticulated slot 11 along the rear section of the top edge, a rectangular slot 12 at the front section of the top edge and, furthermore, a counter sunk screw hole 13 disposed horizontally through the center of said left case half 1.

The right case half 2 is a shell of one-piece molded construction having a reticulated slot 21 along the rear section of the top edge, a rectangular slot 22 at the front section of the top edge and, at the inner edge along one side of said right case half 2, a plurality of detent notches 23, with said right case half 2 at the front section of its inner side also consisting of a blade mount plate 24 and, furthermore, said right case half 2 has a threaded hole 25 in the center section of its inner side.

Said pad 3 is one-piece molded of a pliant plastic material that enhances holding comfort as well as stability.

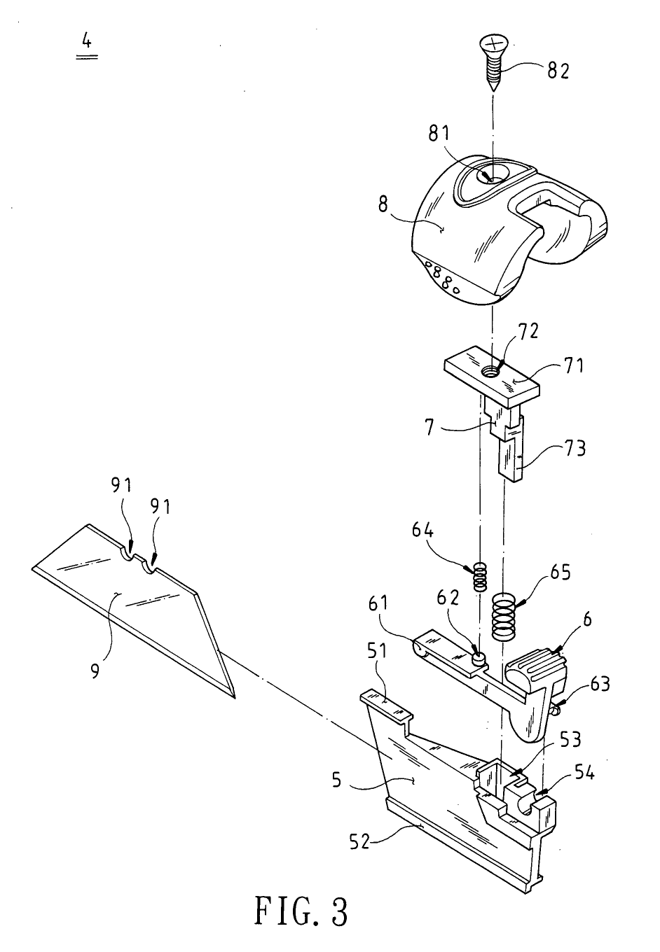

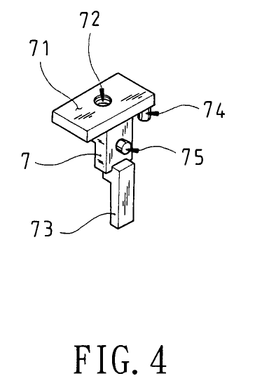

The blade control mechanism 4, as indicated in FIG. 3 and FIG. 4, consists of a blade mount 5, a blade replacement key 6, a push button support mount 7, a push button 8, and other structural components, wherein:

The push button support mount 7, at its top edge, has a rectangular anchor plate 71, said anchor plate 71 having disposed at the center a threaded hole 72, said anchor plate 71 having a rectangular locating post 73 at its lower extent as well as a cylindrical post 74 below its front edge and, furthermore, said push button support mount 7, at the lateral center position of its body, also has a cylindrical post 75.

The push button 8 is a semicircular, saddle-shaped physical entity, with a counter sunk screw hole 81 through the center of its top surface.

The blade replacement key 6, at one side of its anterior bottom edge, has a semicircular, arcuate pawl 61, with a cylindrical post 62 at the center of its top edge and, furthermore, a support shaft 63 projecting from the tail end of the blade replacement key 6.

The blade mount 5 has disposed along the upper extent of its front end a T-shaped, projecting element 52, said blade mount 5 also has at its center a rectangular recess 53 and, furthermore, said blade mount 5 has, at the upper extent of its tail end, a semicircular notch 54.

Said blade control mechanism 4 consists of, at one side of its tail end, the blade replacement key 6, the support shaft 63, which fits into the semicircular notch 54 at the upper extent of its tail end, with said push button support mount 7 having insertionally disposed, between its cylindrical post 74 and the cylindrical post 62 protruding from the center of the blade replacement key 6, a spring 64 and, furthermore, the locating post 73 at the lower extent of said anchor plate 71 is inserted through a spring 65 and then seated in the rectangular recess 53 of the blade mount 5, the blade 9 in the present invention has semicircular check notches 91 disposed along its top edge, that are individually engaged by the pawl 61 at one side of the anterior bottom edge of the blade replacement key 6, said components thereby enabling the assembly of the blade control mechanism 4.

In the blade control mechanism 4 of the invention herein, the cylindrical post 74 at the side of the push button support mount 7 is insertionally positioned in a semicircular detent notch 23 along the front section inside the right case half 2; said pad 3 is fitted into the slot 21 along the rear section of the top edge of the right case half 2, the right case half 2 and the left case half 3 are then placed together, and a mounting screw 14 is inserted through the left case half 3 counter sunk screw hole 13 and fastened into the right case half threaded hole 25; said push button 8, by means of a screw 82 inserted through a counter sunk hole 81 at the center of its upper extent, is fastened into the threaded hole 72 at the center of the push button support mount 7 anchor plate 71, thereby enabling the assembly of a complete art knife structure.

The push button support mount 7 cylindrical post 75 is seated in the right case half 2 semicircular detent notch 23, but when the push button 8 is pressed downward, the cylindrical post 75 is disengaged from the detent notch 23, resulting in the outward impelling of the push button 8, and the drawing of the blade mount 5, the blade replacement key 6, and the blade 9 such that they slide outward until the blade 9 reaches a suitable position at which time the push button 8 is released, said push button 8 springs 64 and 65 elastic force is then directed upward for the return ascent, thereby reseating the cylindrical post 75 in the detent notch 23, which achieves safe and stable blade forwarding operation; to retract the blade 9, the same routine is executed in reverse by pulling up the push button 8.

To change blades, when the blade 9 is extended from the art knife body, the blade replacement key 6 is pressed downward, said blade replacement key 6, by means of its support shaft 63 which serves as swaying pivot point, enables the pawl 61 at the front end of the blade replacement key 6 to become disengaged from the blade 9 check notch 91, allowing the removal of the blade 9 and the loading of a new blade 9 into the body of the art knife, and after the release of the blade replacement key 6, the elastic force of said blade replacement key 6 spring 64 enables the pawl 61 to become re-engaged in the blade 9 check notch 91, which completes the blade changing operation.

In summation of the foregoing section, since the invention herein is certainly capable of the claimed utilitarian objectives, and the disclosed general structure possesses practical value as well as exceptional efficiency, the present invention is submitted to the examination committee for review and the granting of the commensurate patent rights.

What is claimed is:

1. An art knife comprised of a left case half, a right case half, a pad, and a blade control mechanism, wherein:
said left case half is a shell of one-piece molded construction having a reticulated slot along the rear section of the top edge, a rectangular slot at the front section of the top edge and, furthermore, a counter sunk screw hole is disposed horizontally through the center of said left case half;
said right case half is a shell of one-piece molded construction having a reticulated slot along the rear section of the top edge, a rectangular slot at the front section of the top edge and, at the inner edge along one side of said right case half, a plurality of semicircular detent notches, with said right case half at the front section of its inner side also consisting of a blade mount plate and, furthermore, said right case half has a threaded hole in the center section of its inner side;
said pad is one-piece molded of a pliant plastic material that enhances holding comfort as well as stability;
said blade control mechanism consists of a blade mount, a blade replacement key, a push button support mount, a push button, and other structural components, wherein:
said push button support mount, at its top edge, has a rectangular anchor plate, said anchor plate having disposed at the center a threaded hole, said anchor plate having a rectangular locating post at its lower extent as well as a cylindrical post below its front edge and, furthermore, said push button support mount, at the lateral center position of its body, also has a cylindrical post;
said push button is a semicircular, saddle-shaped physical entity, with a counter sunk screw hole through the center of its top surface;
said blade replacement key, at one side of its anterior bottom edge, has a semicircular, arcuate pawl, with a cylindrical post at the center of its top edge and, furthermore, a support shaft projects from the tail end of said blade replacement key;
said blade mount has disposed along the upper extent of its front end a T-shaped, projecting element, said blade mount also has at its center a rectangular recess and, furthermore, said blade mount has, at the upper extent of its tail end, a semicircular notch;
said blade control mechanism consists of, at one side of its tail end, said blade replacement key support shaft, which fits into said semicircular notch at the upper extent of its tail end, with said push button support mount having insertionally disposed, between its said cylindrical post and said cylindrical post protruding from the center of said blade replacement key, a spring and, furthermore, said locating post at the lower extent of said anchor plate is inserted through a second spring and then seated in said rectangular recess of said blade mount, the blade in the present invention has semicircular check notches disposed along its top edge that are individually engaged by said pawl at one side of the anterior bottom edge of said blade replacement key, said components enabling the assembly of the blade control mechanism;
in said blade control mechanism of the invention herein, said cylindrical post at the side of said push button support mount is insertionally positioned in a said semicircular detent notch along the front section inside said right case half; said pad is fitted into said slot along the rear section of the top edge of said right case half, said right case half and said left case half are then placed together, and a mounting screw is inserted through said left case half counter sunk screw hole and fastened into said right case half threaded hole; said push button, by means of a screw inserted through a counter sunk hole at the center of its upper extent, is fastened into said threaded hole at the center of said push button support mount anchor plate, thereby enabling the assembly of a complete art knife structure.
